(19) United States
(12) Patent Application Publication
(10) Pub. No.: US 2011/0121571 A1
(43) Pub. Date: May 26, 2011

(54) TORQUE TRANSMITTING MECHANISM OF AN INTERNAL COMBUSTION ENGINE, A VEHICLE AND A METHOD OF TRANSMITTING TORQUE

(75) Inventor: Robert WARTANIAN, Riedstadt (DE)

(73) Assignee: GM GLOBAL TECHNOLOGY OPERATIONS, INC., Detroit, MI (US)

(21) Appl. No.: 12/908,633

(22) Filed: Oct. 20, 2010

(30) Foreign Application Priority Data
Oct. 20, 2009 (GB) 0918405.2

(51) Int. Cl. F02N 11/04

(52) U.S. Cl. 290/46

(57) ABSTRACT

A torque transmitting mechanism of an internal combustion engine includes, but is not limited to a starter-generator, a crankshaft side member that rotates in conjunction with a crankshaft, a first one-way clutch arranged to transmit torque from the starter to the crankshaft side member and a second one-way clutch arranged to transmit torque from the crankshaft side member to the generator. The starter is in at least substantially constant engagement with the crankshaft side member.

### CROSS-REFERENCE TO RELATED APPLICATION

This application claims priority to British Patent Application No. 0918405.2, filed Oct. 20, 2009, which is incorporated herein by reference in its entirety.

### TECHNICAL FIELD

The present application relates to a torque transmitting mechanism of an internal combustion engine, a vehicle comprising a torque transmitting mechanism and a method of transmitting torque in an internal combustion engine.

### BACKGROUND

It is desirable to reduce fuel consumption as well as the emissions of internal combustion engines and, in particular, internal combustion engines of automotive vehicles. Various approaches may be used, either singly or together. For example, the fuel consumption may be reduced by more efficient fuel combustion and/or reducing the weight of the vehicle. Consumption of fossil fuels such as petrol and diesel may be reduced by providing an additional energy source such as a battery in so-called hybrid-drive systems.

Techniques such as regenerative braking may also be used to regain energy which would otherwise be dissipated in the form of heat. This regained energy can be used to power either the vehicle or auxiliary systems within the vehicle. Other approaches include stop and start systems in which the internal combustion engine is automatically switched off should the vehicle temporarily stop and the engine idle. The internal combustion engine is restarted when the driver wishes to move forward and operates the clutch. These methods are useful for improving fuel efficiency in heavy traffic situations which may occur in towns and cities, particularly during the rush hour.

DE 10 2004 008 649 A1 discloses a drive system for an internal combustion engine in which a starter-generator is coupled to the crankshaft by a belt. The starter is used to start the engine by driving the crankshaft and, during operation of the engine, the crankshaft drives the generator. A free engine clutch is provided in this drive system between a drive wheel and a generator shaft that links the drive wheel to the generator shaft when the internal combustion engine drives the generator and releases this link if drive torque is low or equals zero. The free engine clutch is bypassed by an engaging and disengaging a clutch when the starter-generator starts up or cranks the internal combustion engine.

Accordingly, it is desirable to further improve fuel economy. In addition, other improvements, desirable features, and characteristics will become apparent from the subsequent detailed description, and the appended claims, taken in conjunction with the accompanying drawings and this background.

### SUMMARY

A torque transmitting mechanism of an internal combustion engine is provided that comprises a starter-generator, a crankshaft side member which rotates in conjunction with a crankshaft, a first one-way clutch arranged to transmit torque from the starter to the crankshaft side member and a second one-way clutch arranged to transmit torque from the crankshaft side member to the generator. The starter is in constant engagement with the crankshaft side member.

The torque transmitting mechanism enables torque to be transmitted between the starter-generator and the crankshaft. In particular, the first one-way clutch enables torque to be transmitted from the starter to the crankshaft side member, the crankshaft and the internal combustion engine. The second one-way clutch enables torque to be transmitted from the crankshaft side member to the generator and regain energy from the rotating crankshaft which is fed into the generator. The starter-generator may be provided in the form of a combined starter-generator and may replace a starter-alternator system.

The starter is in constant engagement with the crankshaft side member. The torque transmitting mechanism can be used as part of a stop and start system that is quick efficient since the torque can be quickly transmitted from the starter to the crankshaft side member when the engine starts, since the starter is in constant engagement with the crankshaft side member. Furthermore, the engine does not have to be stopped completely for the starter to drive the crankshaft side member since the starter is constantly engaged with the crankshaft side member. Therefore, the torque transmitting mechanism according to the present application enables the fuel economy of the internal combustion engine to be further improved.

In an embodiment, the starter is configured to drive the crankshaft side member and to drive the crankshaft when the first one-way clutch is engaged and the crankshaft is configured to drive the generator upon engagement of the second one-way clutch. In particular, the first and second clutches are configured so that only one of the first and second clutches is engaged at any one time so that the two torque transmitting directions are decoupled from one another. Therefore, torque can either be transmitted either from the starter to the crankshaft side member or from the crankshaft to the generator. This increases the efficiency of the system.

The starter-generator is coupled to the crankshaft by two independent drives which are operated one at a time. The starter-generator may be coupled to the crankshaft side member using various drive mechanisms. The two drives may operate on the same principle or may be different. In an embodiment, the crankshaft side member is coupled to the starter by a gear drive and to the generator by a belt drive. The belt drive may be a V-Belt drive, a timing chain drive or a flat belt drive.

In an embodiment, the crankshaft side member comprises a first ring gear for coupling the crankshaft side member to the starter via a gear drive and a pulley for coupling the crankshaft side member to the generator via a belt drive.

In one embodiment, the starter is coupled to the first ring gear by a pinion gear which is in constant mesh with the first ring gear so that the starter is in constant engagement with the crankshaft side member.

In a further embodiment, the generator is coupled to the crankshaft side member by a belt drive, a timing chain drive or a gear pair. A belt drive or timing chain drive may be used if the arrangement is situated in the air. A gear pair may be used if the arrangement is situated in oil.

In a further embodiment, whilst the starter drives the crankshaft, the second clutch is disengaged so that the second drive, e.g., the belt drive, freewheels and torque is not transmitted from the crankshaft to the generator. The generator is decoupled from the crankshaft.

In a further embodiment, whilst the crankshaft drives the generator, the first clutch is disengaged so that the first drive, e.g., a gear drive, freewheels and the starter is decoupled from the crankshaft side member so that torque is not transmitted from the starter to the crankshaft side member.

In an embodiment, the first one-way clutch is configured to be actuated at a predetermined rpm (revolutions per minute) of the crankshaft to decouple the starter from the crankshaft. This configuration enables the starter to be coupled to the crankshaft so as to start the crankshaft rotating and start the internal combustion engine. Once a predetermined rpm of the crankshaft has been reached which is indicative that the engine is running, the first one-way clutch is actuated so as to decouple the starter from the crankshaft. This decoupling may occur automatically as a result of the design of the first one-way clutch.

In a further embodiment, the second one-way clutch is configured to be actuated above this predetermined rpm of the crankshaft so as to couple the crankshaft to the generator so that the crankshaft can drive the generator once the internal combustion engine is running. Since the second one-way clutch is actuated above the predetermined rpm, the crankshaft is coupled to the generator only when the starter is decoupled from the crankshaft.

In a further embodiment, the one-way clutch transmits torque generated by the starter from the first ring gear to the crankshaft in one direction and prevents torque from being transmitted in the opposing direction. This enables the starter to be reliably coupled and decoupled from the crankshaft.

The application also provides a vehicle comprising an internal combustion engine, such as diesel engine or spark ignition engine, which is coupled to a crankshaft and further comprises a torque transmitting mechanism according to one of the embodiments described above.

The application also provides a method of transmitting torque in an internal combustion engine between a starter-generator and a crankshaft which is coupled to the internal combustion engine. The starter is in constant engagement with a crankshaft side member which rotates in conjunction with the crankshaft. The method comprises engaging a first one-way clutch and transmitting torque from the starter to the crankshaft side member to drive the crankshaft side member and the crankshaft. A second one-way clutch is engaged to transmit torque from the crankshaft side member to the generator in order to drive the generator. More particularly, at any one time, torque is transmitted either from the crankshaft side member to the generator or from the starter to the crankshaft side member. Torque is transmitted in only one direction at any one time.

If the rpm of the crankshaft is zero and the internal combustion engine the switched off, the first one-way clutch may be engaged to couple the starter to the crankshaft so that torque can be transmitted from the starter to the crankshaft and start the internal combustion engine.

The first one-way clutch may be disengaged at a predetermined rpm of the crankshaft so as to decouple the starter from the crankshaft. The predetermined rpm may be indicative that the internal combustion engine is running.

In a further embodiment, the second one-way clutch is engaged at an rpm above the predetermined rpm of the crankshaft so as to couple the crankshaft to the generator and transmit torque from the crankshaft to the generator as well as to the transmission of the vehicle. Therefore, the switchover in the torque direction is dependent on the rpm of the crankshaft.

During engine starting, the first one-way clutch is engaged so that the crankshaft is driven by the starter. The starter's driving force is transferred to the engine crankshaft. Once the engine is running, the first one-way clutch freewheels and the engine's driving force is transferred to the transmission. The second one-way clutch may be engaged so as to engage the generator with the crankshaft so that, additionally, the crankshaft drives the generator.

The mechanism which couples the starter to the crankshaft and the mechanism which couples the generator with the crankshaft are decoupled. Therefore, the torque transmitting mechanism includes two drives which are decoupled from one another and operated independently and generally alternately.

The starter-generator may replace a starter motor and alternator so as to reduce weight and further improve fuel efficiency.

### BRIEF DESCRIPTION OF THE DRAWINGS

The present invention will hereinafter be described in conjunction with the following drawing figures, wherein like numerals denote like elements, and.

FIG. 1a illustrates a schematic diagram of a torque transmitting mechanism of an internal combustion engine operated according to a first embodiment;

FIG. 1b illustrates a schematic diagram of a torque transmitting mechanism of the internal combustion engine operated according to a second embodiment;

FIG. 2 illustrates a perspective view of the torque transmitting mechanism of an internal combustion engine according to a third embodiment;

FIG. 3 illustrates a side view of the torque transmitting mechanism of FIG. 2; and

FIG. 4 illustrates a second perspective view of the torque transmitting mechanism of FIG. 2.

### DETAILED DESCRIPTION

The following detailed description is merely exemplary in nature and is not intended to application and uses. Furthermore, there is no intention to be bound by any theory presented in the preceding background or summary or the following detailed description.

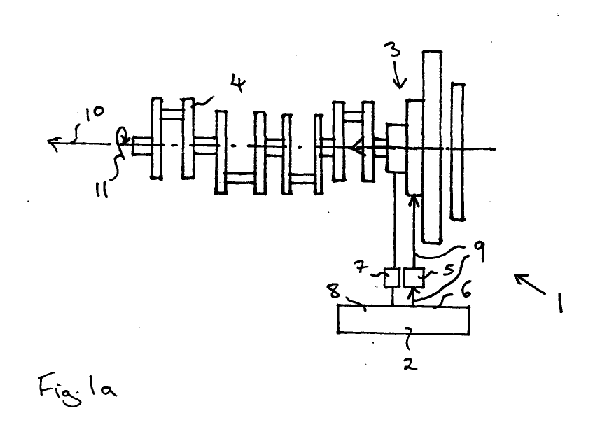

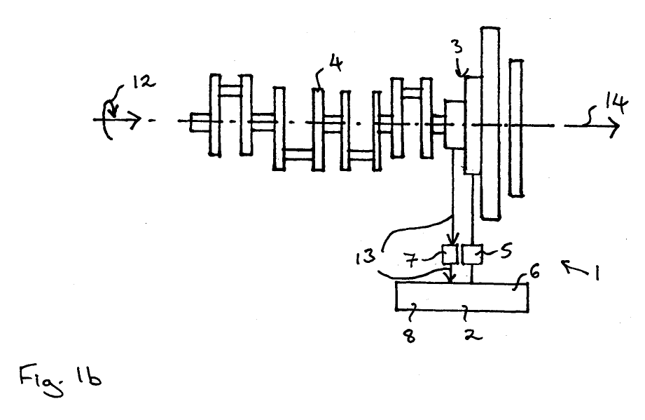

A torque transmitting mechanism 1 of a non-illustrated internal combustion engine of a vehicle is illustrated schematically in FIG. 1a and FIG. 1b. In particular, FIG. 1a and FIG. 1b illustrate two different torque transmitting paths of the torque transmitting mechanism 1.

The torque transmitting mechanism 1 comprises a starter-generator 2 and a crankshaft side member 3 which rotates in conjunction with a crankshaft 4 which is coupled to the internal combustion engine. The starter-generator 2 may be a combined starter-generator unit. The torque transmitting mechanism 1 also comprises a first one-way clutch 5 arranged to transmit to torque from the starter motor 6 of the starter-generator 2 to the crankshaft side member 3 and prevent torque from being transmitted in the opposing direction from the side crankshaft member 3 to the starter motor 6.

The torque transmitting mechanism 1 also includes a second one-way clutch 7 arranged to transmit torque from the crankshaft side member 3 to the generator 8 of the starter-generator 2 and prevent torque from being transmitted in the opposing direction from the generator 8 to the crankshaft side member 3. The starter motor 6 is in constant engagement with the crankshaft side member 3. Although the starter motor 6 is in constant engagement with the crankshaft side member 3, the first one-way clutch 5 couples and decouples the starter motor 6 from the crankshaft side member so that torque is either transmitted to the crankshaft side member 3 or is not transmitted to the crankshaft side member 3, respectively. However, since the starter motor 6 is in constant engagement with the crankshaft side member 3, the torque can be quickly and efficiently transferred from the starter motor 6 to the crankshaft side member 3 to start the internal combustion engine. This is useful in stop and start operation in which the internal combustion engine is automatically switched off when the engine idles and automatically restarted when the driver wishes to pull off.

FIG. 1a illustrates a first operating mode of the torque transmitting mechanism 1 in which the starter motor 6 transmits torque to the crankshaft side member 3, indicated by arrows 9, which is transmitted to the crankshaft 4, indicated by arrow 10, in order to rotate the crankshaft 4 as indicated by arrow 11. This operating mode may be used to start the internal combustion engine. In this embodiment, the first one-way clutch 5 is actuated so as to transmit torque from the starter motor 6 to the crankshaft side member 3 and crankshaft 4.

FIG. 1b illustrates a second operating mode of the torque transmitting mechanism 1 in which the first one-way clutch 5 is actuated so as to decouple the starter motor 6 from the crankshaft side member 3 and crankshaft 4 and in which the second one-way clutch 7 is actuated so as to couple the crankshaft side member 3 to the generator 8. In this second operating mode, the internal combustion engine is running and the crankshaft 4 is rotating and is driven by the internal combustion engine as indicated by arrow 12. The torque is transmitted from the crankshaft 4 and crankshaft side member 3 that rotates conjunction with the crankshaft 4 to the generator 6 as indicated by the arrows 13. In this embodiment, the starter motor 6 is still in constant engagement with the crankshaft side member 3 but decoupled from the crankshaft side member 3 so that torque is not transferred to or from the starter motor 6. In this embodiment, torque from the internal combustion engine is transmitted via the crankshaft 4 to the transmission of the vehicle as illustrated by the arrow 14.

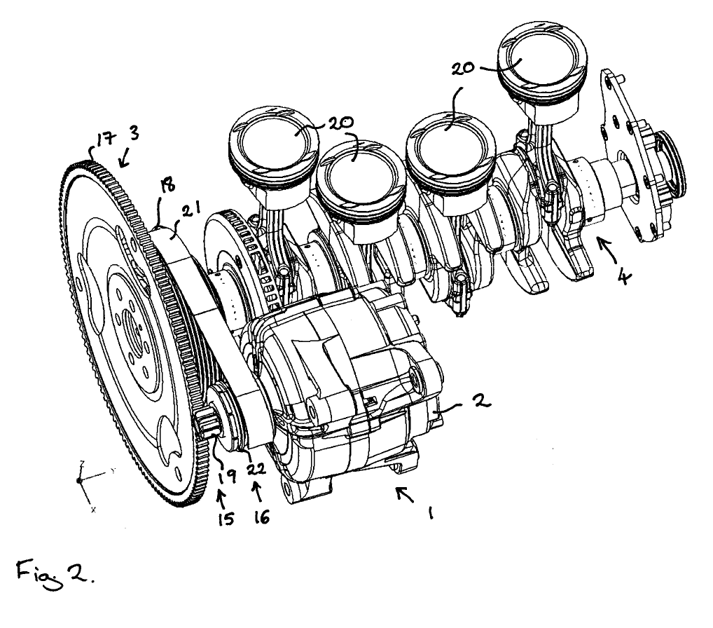

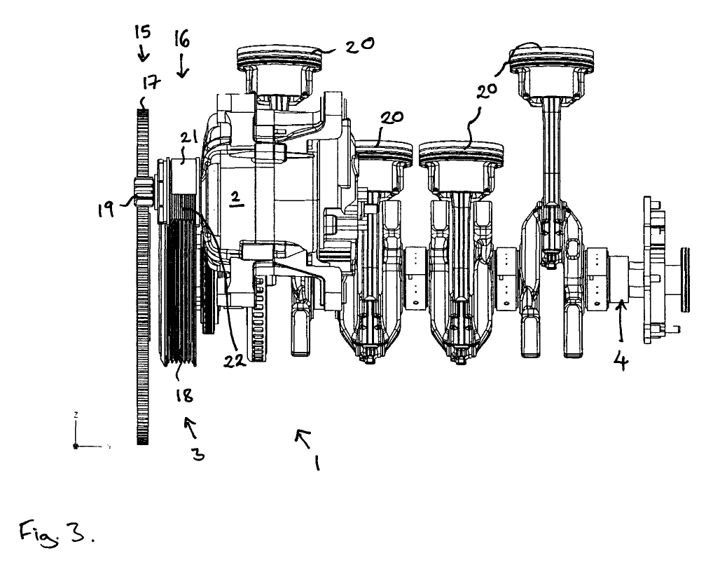

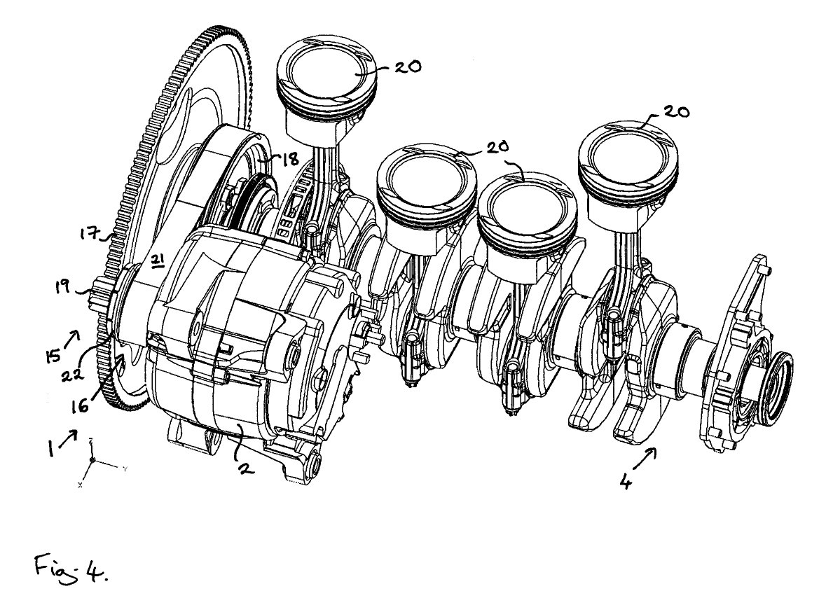

FIG. 2 to FIG. 4 illustrate different perspective views of a torque transmission system 1′ according to a third embodiment. In all of the figures, the same reference numeral is used to indicate similar or identical parts.

The torque transmitting mechanism 1′ according to the second embodiment comprises a combined starter-generator 2 which is coupled to a crankshaft side member 3 which rotates in conjunction with a crankshaft 4. The coupling rods 20 which couple the crankshaft 4 to the internal combustion engine and translate in the reciprocating motion of the pistons within cylinders of the internal combustion engine to rotational movement of the crankshaft are also illustrated in FIG. 2 to FIG. 4.

The starter-generator 2 includes a gear drive 15 and a belt drive 16 which are decoupled from one another and which are driven independently of one another. The crankshaft side member 3 includes a first ring gear 17 which is coupled to a pinion gear 19 of the gear drive 15 which couples the starter-generator 2 and, in particular, the starter motor 6 of the combined starter-generator 2, to the crankshaft 4. The pinion gear 19 is in constant mesh with the first ring gear 17.

The crankshaft side member 3 also comprises a pulley 18 which couples the crankshaft 4 to a pulley 22 on the starter-generator 2 by belt 21 to form a belt drive 16. In particular, the belt drive 16 couples the crankshaft 4 to the generator 8 of the starter-generator 2.

The pulley 22 is arranged concentrically around the shaft axis of pinion gear 19 so that the pinion gear 19 protrudes from a central through-hole arranged in the pulley 22. The pinion gear 19 and pulley 22 are arranged separately from one another so that each can be driven independently of the other.

The first one-way clutch 5 is positioned between the first ring gear 17 and the crankshaft 4 and is configured to couple the first gear drive 15 to the crankshaft 4 so as to transmit torque from the starter motor 6 to the crankshaft 4 and thus start the engine. The first one-way clutch 5 and gear drive 15 may be of the type disclosed in WO 2007/148228 which is hereby incorporated by reference in its entirety.

The starter motor 6 is driven by a non-illustrated 12 volt power supply. Whilst the starter motor 6 transmits torque to the crankshaft 4 by means of the gear drive 15, the belt drive 16 freewheels. As the starter motor 6 drives the crankshaft 4, the rpm of the crankshaft and internal combustion engine increases and at a predetermined rpm, the external power supply is disconnected from the starter motor 6 and the gear drive 15 is decoupled from the crankshaft 4 so that the gear drive 15 freewheels.

Once the rpm of the engine is above this predetermined limit, the second one-way clutch 7 is actuated so as to couple the belt drive 16 to the crankshaft 4 by means of the pulleys 18, 22 and belt 21 so that torque is transmitted from the crankshaft 4 to the generator 8. In this embodiment, the second one-way clutch 7 is positioned within the housing of the starter-generator 2. Whilst the generator 8 is coupled to the crankshaft 4 by the belt drive 16, the gear drive 15 freewheels. The generator generates electricity which may be stored in the battery of the vehicle or used directly to power the vehicle or auxiliary systems of the vehicle.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A torque transmitting mechanism of an internal combustion engine, comprising:
a crankshaft side member adapted to rotate in conjunction with a crankshaft,
a starter and a generator in substantially constant engagement with the crankshaft side member;
a first one-way clutch adapted to transmit torque from the starter and the generator to the crankshaft side member; and
a second one-way clutch adapted to transmit torque from the crankshaft side member to the generator.

2. The torque transmitting mechanism according to claim 1,
wherein upon engagement of the first one-way clutch, the starter is configured to drive the crankshaft side member and to drive the crankshaft, and
wherein upon engagement of the second one-way clutch, the crankshaft is configured to drive the generator.

3. The torque transmitting mechanism according to claim 1, wherein the first clutch and the second clutch are configured so that only one of the first clutch and the second clutch is engaged.

4. The torque transmitting mechanism according to one of claim 1, wherein the crankshaft side member comprises a ring gear.

5. The torque transmitting mechanism according to claim 4, wherein the starter is coupled to the ring gear by a pinion gear in substantially constant mesh with the ring gear.

6. The torque transmitting mechanism according to claim 1, wherein the generator is coupled to the crankshaft side member by a belt drive.

7. The torque transmitting mechanism according to claim 6, wherein the generator is coupled to the crankshaft side member by a V-belt drive.

8. The torque transmitting mechanism according to claim 1, wherein the generator is coupled to the crankshaft side member by a timing chain drive.

9. The torque transmitting mechanism according to claim 1, wherein the generator is coupled to the crankshaft side member by a gear pair.

10. The torque transmitting mechanism according to claim 4, wherein while the crankshaft drives the generator, the first clutch is disengaged for freewheeling of the ring gear.

11. The torque transmitting mechanism according to claim 6, wherein while the starter drives the crankshaft, the second clutch is disengaged for freewheeling of the belt drive.

12. The torque transmitting mechanism according to claim 1, wherein the first one-way clutch is configured to be actuated at a predetermined rpm of the crankshaft and decouple the starter from the crankshaft.

13. The torque transmitting mechanism according to claim 9, wherein the second one-way clutch is configured to be actuated above the predetermined rpm of the crankshaft and couple the crankshaft to the generator.

14. The torque transmitting mechanism according to claim 4, wherein the first one-way clutch is configured to transmit torque generated by the starter from the ring gear to the crankshaft in one direction and prevents transmission of torque in the opposing direction.

15. A vehicle comprising,
an internal combustion engine; and
a torque transmitting mechanism for the internal combustion engine, the torque transmitting mechanism comprising:
a crankshaft side member adapted to rotate in conjunction with a crankshaft,
a starter and a generator in substantially constant engagement with the crankshaft side member;
a first one-way clutch adapted to transmit torque from the starter and the generator to the crankshaft side member; and
a second one-way clutch adapted to transmit torque from the crankshaft side member to the generator.

16. The vehicle according to claim 15,
wherein upon engagement of the first one-way clutch, the starter is configured to drive the crankshaft side member and to drive the crankshaft, and
wherein upon engagement of the second one-way clutch, the crankshaft is configured to drive the generator.

17. The vehicle according to claim 15, wherein the first clutch and the second clutch are configured so that only one of the first clutch and the second clutch is engaged.

18. A method of transmitting torque in an internal combustion engine between a starter, a generator, and a crankshaft, the starter in substantially constant engagement with a crankshaft side member that rotates in conjunction with the crankshaft, the method comprising the steps of:
engaging a first one-way clutch;
transmitting torque from the starter to the crankshaft side member to drive the crankshaft side member and the crankshaft;
engaging a second one-way clutch; and
transmitting torque from the crankshaft side member to the generator to drive the generator.

19. The method according to claim 18, further comprising the step of disengaging the first one-way clutch at a predetermined rpm of the crankshaft to decouple the starter from the crankshaft.

20. The method according to claim 18, further comprising engaging the second one-way clutch above a predetermined rpm of the crankshaft to couple the crankshaft to the generator.
